(19) United States
(12) Patent Application Publication
(10) Pub. No.: US 2010/0317233 A1
(43) Pub. Date: Dec. 16, 2010

(54) ELECTRICAL CONNECTION SYSTEM

(76) Inventor: Jae-Yong Koh, Seoul (KR)

Correspondence Address: HAYES SOLOWAY P.C., 3450 E. SUNRISE DRIVE, SUITE 140, TUCSON, AZ, 85718, US

(21) Appl. No.: 12/824,033

(22) Filed: Jun. 25, 2010

Related U.S. Application Data
(63) Continuation-in-part of application No. PCT/KR2008/007714, filed on Dec. 26, 2008.

(30) Foreign Application Priority Data
Dec. 26, 2007 (KR) 10-2007-0137580

(51) Int. Cl. H01R 24/00

(52) U.S. Cl. 439/626

(57) ABSTRACT

Provided is a connection structure between electronic modules, each having a plurality of terminals and a plurality of electrodes, and more particularly, an electrical connection system between electrical modules in which terminals and electrodes included in electronic modules are easily connected in an electrical manner.

In an electrical connection system between a fixed module and a moving module, the fixed module comprises a cradle surface on which a concave-convex surface comprising a plurality of convex surfaces and a plurality of concave surfaces is repetitively arranged, in which a commonly connected first-pole terminal is formed on the plurality of convex surfaces and a commonly connected second-pole terminal is formed on the plurality of concave surfaces, the moving module comprises a contact surface corresponding to the cradle surface of the fixed module, the contact surface comprising a planar portion and at least one protruding portion protruding from the planar portion, a first load electrode, which is a conductive member connected to a first pole of a moving module load included in the moving module, is formed on at least a part of a surface of the planar portion, and a second load electrode, which is a conductive member connected to a second pole of the moving module load, is formed in an end portion of the protruding portion, the first load electrode and the second load electrode being insulated from each other, the end portion of the protruding portion is received in any one of the plurality of concave surfaces of the fixed module such that the second load electrode is connected to the second-pole terminal of the fixed module, and the first load electrode is connected to the first-pole terminal of the fixed module.

### TECHNICAL FIELD

The present invention relates to a connection structure between electronic modules, each of which having a plurality of terminals and a plurality of electrodes, and more particularly, to an electrical connection system between electrical modules in which terminals and electrodes included in electronic modules are easily and electrically connected to each other.

### BACKGROUND ART

When modules, each having a plurality of terminals and a plurality of electrodes, are coupled with each other, they have to be positioned suitably for polarities between the respective terminals and electrodes. That is, according to a position in a module where another module is cradled, electrical connection between these modules is maintained or released. For this reason, a user has to take account of the characteristics of the terminals and the electrodes included in the modules for the electric connection between the modules.

Conventional electrical connection systems for facilitating electrical connection between modules have been often suggested in the field of electric charging for portable devices. In this regard, a conventional charging device will be described below.

FIG. 1 illustrates an example of conventional capacitive-coupled contactless charging systems.

In the conventional capacitive-coupled contactless charging system illustrated in FIG. 1, a power supply unit 100 includes a voltage converter 110, a frequency converter 120, a controller 130, and power patches M, and a portable apparatus 200 includes charging contacts N, a rectifier 210, a voltage converter 220, and a storage capacitor 230.

The capacitive-coupled contactless charging system illustrated in FIG. 1 operates as will be described hereinafter. The capacitive-coupled contactless charging system illustrated in FIG. 1 is a charging system operated such that alternating current (AC) power for charging from the power supply unit 100 is applied to the portable apparatus 200 in a capacitive-coupled manner in a contactless state between the plurality of power patches M of the power supply unit 100 for applying power for charging, and the charging contacts N of the portable apparatus 200, the applied AC power is rectified by the rectifier 210 and is converted by the voltage converter 220, and the converted power is used to charge the storage capacitor 230.

FIG. 2 is a block diagram illustrating the structure of a power supply side of a conventional capacitive-coupled charging system.

As illustrated in FIG. 2, the conventional charging system supplies power by using a first MUX 132a and a second MUX 132b, both of which are controlled by a controller 131.

In addition to the charging systems illustrated in FIGS. 1 and 2, a contact-type charging system for bringing the power patches M of the power supply unit 100 into direct contact with the charging contacts N of the portable apparatus 200 to perform charging has been proposed.

In a conventional contact-type charging system, ‘+’ polarity power is supplied in multiple power patches of a power supply unit and at the same time, ‘−’ polarity power is supplied in another multiple power patches of the power supply unit. For this reason, which power patch is to be connected to the ‘+’ pole of a storage capacitor and which power patch is to be connected to the ‘−’ pole of the storage capacitor may be an issue.

To solve such a polarity problem of the power patches, a charging device as illustrated in FIG. 3 has been suggested.

FIG. 3 is a circuit diagram illustrating a charging device including a rectifier for solving the polarity problem of power patches. The charging device illustrated in FIG. 3 includes a plurality of charging contacts 303 connected to a plurality of power patches 302, and a storage capacitor 314 for storing electrical energy.

As illustrated in FIG. 3, the charging contacts 303 are connected to the charging capacitor 314 through a plurality of first and second diodes 315a and 315b. For example, if power applied to a contact Y05 has ‘+’ polarity, the contact Y05 may be connected to the ‘+’ pole of the storage capacitor 314 through the first diode 315a, whereas if power applied to the contact Y05 has ‘−’ polarity, the contact Y05 may be connected to the ‘−’ pole of the storage capacitor 314 through the second diode 315b.

The charging systems illustrated in FIGS. 1 and 2 are problematic in that a control process is very complicated and there are many restrictions in designing to perform a proper control operation.

Since the rectifier illustrated in FIG. 3 is based on a diode device, a problem may occur in light of heat emission and power efficiency. Moreover, for the same reason, a problem may occur in integration. Furthermore, when a rectifier such as a diode is used voltage drop occurs due to the rectifier, resulting in load or malfunction of the storage capacitor.

As discussed above, conventional connection structures between modules (e.g., charging modules and portable apparatus modules) are based on electronic devices, requiring an additional structure for electronic device control and inevitably resulting in heat emission and power efficiency problems.

### DETAILED DESCRIPTION OF THE INVENTION

### Technical Problem

The present invention is conceived to solve the foregoing problems occurring in the prior art, an object of the present invention is to provide an electrical connection system which performs electrical connection by using the characteristics of a mechanical structure included in a module.

Another object of the present invention is to provide an electrical connection system capable of performing electrical connection regardless of a position of each module.

Still another object of the present invention is to provide an electrical connection system which is cheap and simple to manufacture.

### Technical Solution

According to one aspect of the present invention, there is provided an electrical connection system between a fixed module and a moving module, in which the fixed module comprises a cradle surface on which a concave-convex surface comprising a plurality of convex surfaces and a plurality of concave surfaces is repetitively arranged, in which a commonly connected first-pole terminal is formed on the plurality of convex surfaces and a commonly connected second-pole terminal is formed on the plurality of concave surfaces, the moving module comprises a contact surface corresponding to the cradle surface of the fixed module, the contact surface comprising a planar portion and at least one protruding portion protruding from the planar portion, a first load electrode, which is a conductive member connected to a first pole of a moving module load included in the moving module, is formed on at least a part of a surface of the planar portion, and a second load electrode, which is a conductive member connected to a second pole of the moving module load, is formed in an end portion of the protruding portion, the first load electrode and the second load electrode being insulated from each other, the end portion of the protruding portion is received in any one of the plurality of concave surfaces of the fixed module such that the second load electrode is connected to the second-pole terminal of the fixed module, and the first load electrode is connected to the first-pole terminal of the fixed module.

The electrical connection system comprises a transverse movement unit for moving the protruding portion in a direction parallel to the contact surface.

The transverse movement unit comprises a conductive movable member connected to the protruding unit, a rotation member inserted into a plurality of grooves formed on a surface of the conductive movable member to move the conductive movable member, and a conductive support supporting the rotation member wherein the conductive support is connected to the second pole of the moving module load.

The electrical connection system further comprises a longitudinal movement unit for moving the protruding portion in a direction perpendicular to the contact surface.

The longitudinal movement unit comprises an elastic member connected to the protruding portion and elastically transformed in the direction perpendicular to the contact surface, and a support supporting the elastic member.

According to another aspect of the present invention, there is provided an electrical connection system between a fixed module and a moving module, in which the fixed module comprises a cradle surface on which a concave-convex surface comprising a plurality of convex surfaces and a plurality of concave surfaces is repetitively arranged, in which a commonly connected first-pole terminal is formed on the plurality of convex surfaces and a commonly connected second-pole terminal is formed on the plurality of concave surfaces, the moving module comprises a contact surface corresponding to the cradle surface of the fixed module, in which the contact surface comprises a planar portion and a plurality of holes and an electrode pin comprising a push type on-off switch is installed in each of the plurality of holes, a first load electrode, which is a conductive member connected to a first pole of a moving module load included in the moving module, is formed on at least a part of a surface of the planar portion, and the electrode pin is turned off when being withdrawn and is connected to a second load electrode, which is a conductive member connected to a second pole of the moving module load, when protruding, the first load electrode and the second load electrode being insulated from each other, the electrode pin short-circuits the second load electrode and the second-pole terminal of the fixed module when being received in any one of the plurality of concave surfaces of the fixed module, and electrically opens the second load electrode and the second-pole terminal of the fixed module when corresponding onto any one of the plurality of convex surfaces of the fixed module, and the first load electrode is connected to the first-pole terminal of the fixed module.

The push type on-off switch comprises a first elastic member connected to a side of the electrode pin and elastically transformed in a direction perpendicular to the contact surface, a conductive member connected to the first elastic member to move in the direction perpendicular to the contact surface, a second elastic member connected to a side of the conductive member and elastically transformed in the direction perpendicular to the contact surface, and a support supporting the second elastic member.

The conductive member has a cylindrical shape and comprises a reception unit formed therein to receive the first elastic member and the electrode pin.

If a pressure applied to the electrode pin is less than a first threshold, a bottom portion of the conductive member is in contact with the second load electrode, and if a pressure applied to the electrode pin is greater than the first threshold, the bottom portion of the conductive member is separated from the second load electrode.

A magnet is further disposed on back surfaces of the first-pole terminal and the second-pole terminal, the electrode pin comprising the push type on-off switch has a ferromagnetic property such that it is in a withdrawn position when a magnetic force does not reach the electrode pin, and is turned to a protruding position when the magnetic force reaches the electrode pin, and the electrode pin is turned to the protruding position by the magnet when corresponding onto any one of the plurality of concave surfaces of the fixed module, such that the second load electrode and the second-pole terminal of the fixed module are short-circuited.

The push type on-off switch comprises a first elastic member connected to a side of the electrode pin and elastically transformed in a direction perpendicular to the contact surface, a conductive member connected to the first elastic member to move in the direction perpendicular to the contact surface, a second elastic member connected to a side of the conductive member and elastically transformed in the direction perpendicular to the contact surface, and a support supporting the second elastic member.

The conductive member has a cylindrical shape and comprises a reception unit formed therein to receive the first elastic member and the electrode pin.

If a pressure applied to the electrode pin is less than a first threshold, a bottom portion of the conductive member is in contact with the second load electrode, and if a pressure applied to the electrode pin is greater than the first threshold, the bottom portion of the conductive member is separated from the second load electrode.

The first-pole terminal and the second-pole terminal of the fixed module supply powers having different electrical potentials.

According to still another aspect of the present invention, there is provided an electrical connection system between a fixed module and a moving module, in which the fixed module comprises a cradle surface on which a concave-convex surface comprising a plurality of convex surfaces and a plurality of concave surfaces is repetitively arranged, in which a commonly connected first-pole terminal is formed on the plurality of convex surfaces and a commonly connected second-pole terminal is formed on the plurality of concave surfaces, the moving module comprises a contact surface corresponding to the cradle surface of the fixed module, in which the contact surface comprises a planar portion and a plurality of holes and an electrode pin comprising a push type selection switch is installed in each of the plurality of holes, the electrode pin is connected to a first load electrode, which is a conductive member connected to a first pole of a moving module load included in the moving module, when being withdrawn, and is connected to a second load electrode, which is a conductive member connected to a second pole of the moving module load, when protruding, the first load electrode and the second load electrode being insulated from each other, and the electrode pin short-circuits the second load electrode and the second-pole terminal of the fixed module to be short-circuited when being received in any one of the plurality of concave surfaces of the fixed module, and short-circuits the first load electrode and the first-pole terminal of the fixe module when corresponding onto any one of the plurality of convex surfaces of the fixed module.

The push type selection switch comprises a first elastic member connected to a side of the electrode pin and elastically transformed in a direction perpendicular to the contact surface, a conductive member connected to the first elastic member to move in the direction perpendicular to the contact surface, a second elastic member connected to a side of the conductive member and elastically transformed in the direction perpendicular to the contact surface, and a support supporting the second elastic member.

The conductive member has a cylindrical shape and comprises a reception unit formed therein to receive the first elastic member and the electrode pin.

If a pressure applied to the electrode pin is less than a first threshold, a bottom portion of the conductive member is in contact with the second load electrode, and if a pressure applied to the electrode pin is greater than a second threshold, a top portion of the conductive member is in contact with the first load electrode.

A magnet is further disposed on back surfaces of the first-pole terminal and the second-pole terminal, the electrode pin comprising the push type selection switch has a ferromagnetic property such that it is in a withdrawn position when a magnetic force does not reach the electrode pin, and is turned to a protruding position when the magnetic force reaches the electrode pin, the electrode pin short-circuits the first load electrode and the first-pole terminal of the fixed module when contacting any one of the plurality of convex surfaces of the fixed module, and the electrode pin is turned to the protruding position by the magnet when corresponding onto any one of the plurality of concave surfaces of the fixed module, such that the second load electrode and the second-pole terminal of the fixed module are short-circuited.

The push type selection switch comprises a first elastic member connected to a side of the electrode pin and elastically transformed in a direction perpendicular to the contact surface, a conductive member connected to the first elastic member to move in the direction perpendicular to the contact surface and made of other components than ferromagnetic substances, a second elastic member connected to a side of the conductive member and elastically transformed in the direction perpendicular to the contact surface, and a support supporting the second elastic member.

The conductive member has a cylindrical shape and comprises a reception unit formed therein to receive the first elastic member and the electrode pin.

If a pressure applied to the electrode pin is less than a first threshold, a bottom portion of the conductive member is in contact with the second load electrode, and if a pressure applied to the electrode pin is greater than a second threshold, a top portion of the conductive member is in contact with the first load electrode.

The first-pole terminal and the second-pole terminal of the fixed module supply powers having different electrical potentials.

According to yet another aspect of the present invention, there is provided an electrical connection system between a fixed module and a moving module, in which the fixed module comprises a cradle surface on which a concave-convex surface comprising a plurality of convex surfaces and a plurality of concave surfaces is repetitively arranged, in which a commonly connected first-pole terminal is formed on the plurality of convex surfaces, a commonly connected second-pole terminal is formed on the plurality of concave surfaces, and a magnet is further disposed on a back surface of the second-pole terminal, the moving module comprises a contact surface corresponding to the cradle surface of the fixed module, in which the contact surface comprises a planar portion and a plurality of holes and an electrode pin comprising a depressed electrode unit is installed in each of the plurality of holes and has a ferromagnetic property such that the electrode pin is in a withdrawn position when a magnetic force does not reach the electrode pin and is turned to a protruding position when the magnetic force reaches the electrode pin, the withdrawn position of the electrode pin being determined as a back of a surface of the planar portion, a first load electrode, which is a conductive member connected to a first pole of a moving module load included in the moving module, is formed on at least a part of the surface of the planar portion, and the electrode pin is connected to a second load electrode, which is a conductive member connected to a second pole of the moving module load, the first load electrode and the second load electrode being insulated from each other, the electrode pin short-circuits the second load electrode and the second-pole terminal of the fixed module when being received in any one of the plurality of concave surfaces of the fixed module, and the first load electrode is connected to the first-pole terminal of the fixed module.

The depressed electrode unit further comprises a first elastic member connected to the electrode pin to cause the electrode pin to be withdrawn when the electrode pin protrudes towards the cradle surface, and a support supporting the first elastic member.

### ADVANTAGEOUS EFFECTS

The electrical connection system according to the present invention can be applied to various systems such as charging devices and data communication devices for portable apparatuses.

With the electrical connection system according to the present invention, electrical connection is possible irrespective of a position of each module. For example, when the present invention is used in a charging device for a portable apparatus, charging is possible regardless of a position of the portable apparatus, thereby providing convenient charging.

Moreover, with the electrical connection system according to the present invention, electrical connection is made without the use of complicated electronic devices, thereby significantly reducing manufacturing cost. Furthermore, even when large current flows for charging, any resistance resulting from semiconductor devices (diodes, BJT, MOSFET) does not occur and thus power waste and heat emission problems can be solved.

### DESCRIPTION OF THE DRAWINGS

FIG. 1 illustrates an example of conventional capacitive-coupled contactless charging system;

FIG. 2 is a block diagram illustrating the structure of a power supply side of a conventional capacitive-coupled charging system;

FIG. 3 is a circuit diagram illustrating a charging device including a rectifier for solving a polarity problem of power patches; and

FIG. 4 is a cross-sectional view for explaining an electric connection system according to a first embodiment of the present invention;

FIGS. 5 through 9 are cross-sectional views for explaining an example of an electric connection system according to a second embodiment of the present invention;

FIGS. 10 through 12 are cross-sectional views for explaining an example of an electric connection system according to a third embodiment of the present invention;

FIGS. 13 through 15 are cross-sectional views for explaining an example of an electric connection system according to a fourth embodiment of the present invention;

FIGS. 16 through 18 are cross-sectional views for explaining an example of an electric connection system according to a fifth embodiment of the present invention;

FIGS. 19 through 21 are cross-sectional views for explaining an example of an electric connection system according to a sixth embodiment of the present invention; and

FIGS. 22 through 24 are cross-sectional views for explaining an example of an electric connection system according to a seventh embodiment of the present invention.

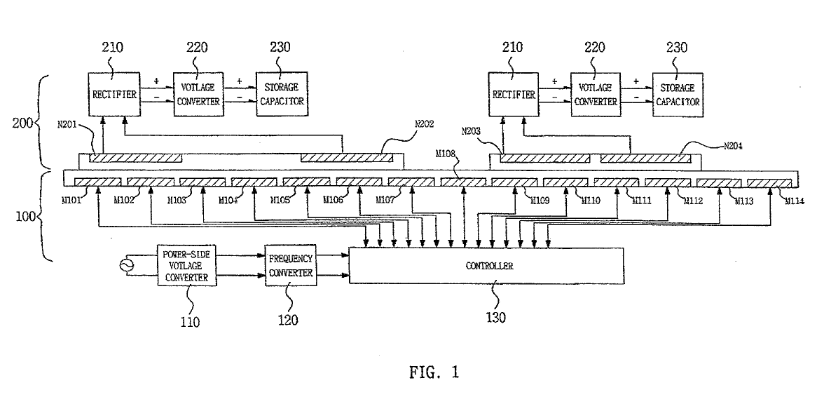

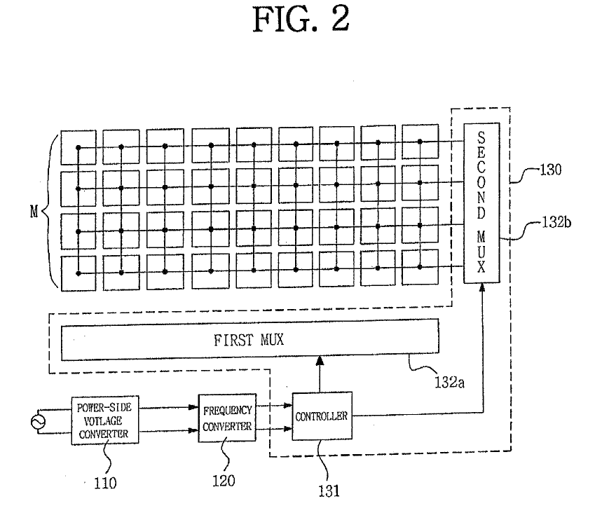

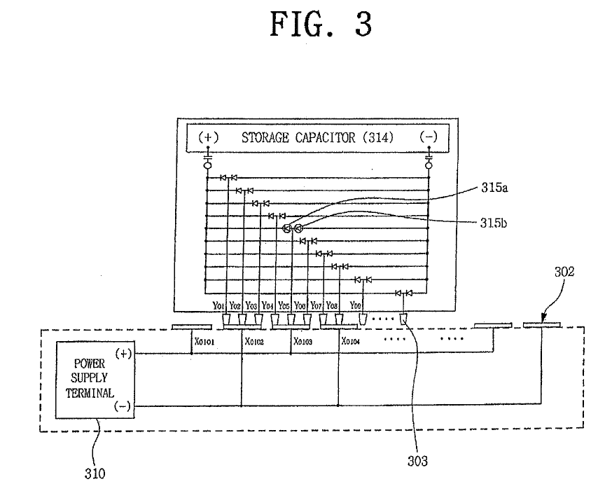

### BEST MODE FOR CARRYING OUT THE INVENTION

Detailed operations and characteristics of the present invention will become clear from the following detailed description of embodiments of the present invention.

The current embodiment of the present invention relates to an electrical connection system between a moving module and a fixed module in which the moving module is cradled. The moving module or the fixed module may be any type of module including electrodes and data terminals. For example, the moving module or the fixed module may be any one of a mobile phone, a portable mp3 player, an adaptor for power supply, a data signal supply source for data signal supply, and the like.

Hereinafter, an electrical connection system according to embodiments of the present invention will be described with reference to the accompanying drawings.

### MODE FOR CARRYING OUT THE INVENTION

### First Embodiment

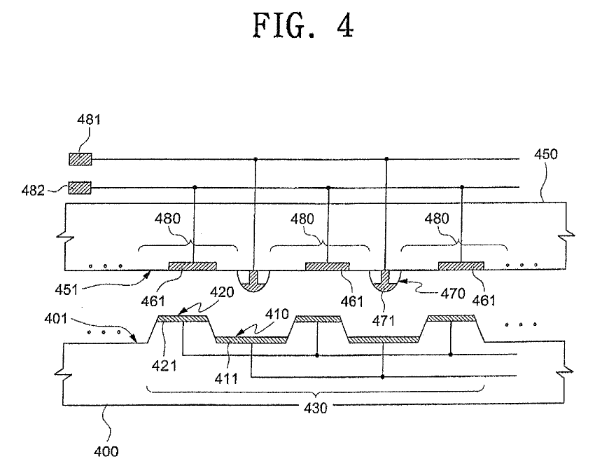

FIG. 4 is a cross-sectional view for explaining an electrical connection system according to a first embodiment of the present invention.

As illustrated in FIG. 4, a fixed module 400 includes a cradle surface 401 on which a concave-convex surface 430 is repetitively arranged. There is no limitation in the shapes of a concave surface 410 and a convex surface 420 included in the concave-convex surface 430, and as illustrated in FIG. 4, the concave-convex surface 430 may have a trapezoid cross section or have a wall shape or a protruding end shape in a vertical or horizontal direction on the cradle surface 401.

The concave surface 410 includes at least one second-pole terminal 411 and the convex surface 420 includes at least one first-pole terminal 421. The first-pole terminal 421 and the second-pole terminal 411 may be formed over the entire concave-convex surface 430 or on a part of the concave-convex surface 430. As illustrated in FIG. 4, the first-pole terminal 421 and the second-pole terminal 411 are commonly connected.

The moving module 450 cradled in the fixed module 400, as illustrated in FIG. 4, includes a contact surface 451 facing the cradle surface 401. The contact surface 451 may be divided into a region where a planar portion 480 exists and a region where a protruding portion 470 exists.

At least one protruding portion 470 corresponding to the second-pole terminal 411 is formed on the contact surface 451, and a second load electrode 471 is provided in an end portion of the protruding portion 470. The second load electrode 471, which is a conductive member, is connected to a second pole 481 of a moving module load (not shown) included in the moving module 450.

In the region where the planar portion 480 exists, a first load electrode 461 corresponding to the first-pole terminal 421 is provided. The first load electrode 461 is connected to a first pole 482 of the moving module load. To prevent a short circuit between electrodes, preferably, the first load electrode 461 and the second load electrode 471 are insulated from each other. The insulation between these electrodes may be achieved in various ways. For example, the insulation may be achieved by an interval between the protruding portion 470 and the first load electrode 471. Alternatively, the first load electrode 461 and the second load electrode 471 may be insulated from each other by forming the second load electrode 471 in the end portion of the protruding portion 470 without using the interval.

The moving module load (not shown) is an electrical load of various types such as a battery, an electronic circuit board, a universal serial bus (USB) module, a motor, and the like.

The protruding portion 470 preferably has a shape protruding towards the cradle surface 401, and the shape of an electrode can be liberally determined. For example, it may be manufactured to have a semi-spherical shape, a cylindrical shape, a multi-pillar shape, or the like.

As illustrated in FIG. 4, the fixed module 400 includes the convex surface 420 and the concave surface 410, and the moving module 450 includes the planar portion 480 and the protruding portion 470 corresponding thereto, based on which the moving module 450, when cradled in the fixed module 400, slides naturally along the shape of the concave-convex surface 430. That is, with the structure of the concave-convex surface 430, a protruding electrode of the moving module 450, i.e., the second load electrode 471 is received in the concave surface 410 and the first load electrode 461 is received in the convex surface 420. Once the second load electrode 471 is received in the concave surface 410, contact occurs between the second-pole terminal 411 and the second load electrode 471 and contact occurs between the first-pole terminal 421 and the first load electrode 461.

As previously described, since the second-pole terminal 411 corresponds to the second load electrode 471 and the first-pole electrode 421 corresponds to the first load electrode 461, the first-pole terminal 421 and the second-pole terminal 411 of the fixed module 400 are electrically connected to the first pole 482 and the second pole 481 of the moving module load, respectively.

In the electrical connection system illustrated in FIG. 4, a short circuit may occur between the first load electrode 461 and the second load electrode 471 due to coupling between those two modules 400 and 450, but the moving module load usually includes a power control module (PCM) and thus a problem caused by the short circuit between the load electrodes 461 and 471 can be minimized.

Although a short circuit may occur between the first-pole terminal 421 and the second-pole terminal 411 due to coupling between those two modules 400 and 450, this problem may be solved by properly designing arrangement of those terminals 411 and 412 relative to each other or adding a conventionally suggested over current protection (OCP) or over voltage protection (OVP) module to the fixed module 400.

For example, when the fixed module 400 is a charging device including a power supply source (not shown) and a moving module 450 is a portable device including a battery (not shown), the second-pole terminal 411 and the second load electrode 471 may be VCC terminals of a charging power and a battery having a predetermined potential (e.g., ‘5 ’ volt) and the first-pole terminal 421 and the first load electrode 461 may be GND terminals of the charging power and the battery having a ground potential. In this case, once the portable device is liberally cradled in the cradle surface 401 of the charging device, the portable device slides along the concave-convex surface 430, whereby the VCC terminal of the charging device and the VCC terminal of the portable device are electrically connected to each other and the GND terminal of the charging device and the GND terminal of the portable device are electrically connected to each other, thus normally performing a charging operation.

The modules 400 and 450 having a connections structure as illustrated in FIG. 4 can accurately match their terminals and electrodes along the shape of the concave-convex surface 430 without using conventionally used electronic devices (e.g., diodes, BJT, and MOSFET). When electronic devices are used for electrical connection between modules as in conventional techniques, a complicated structure for controlling the electronic devices has to be added and power waste and heat emission occur due to resistances residing in the electronic devices. In particular, in the case of electrical connection for charging, the amount of current flowing through a device is very large, worsening the power waste and heat emission problems. However, by using a concave-convex or groove shape included in the modules 400 and 450 according to the first embodiment of the present invention, such problems occurring in conventional techniques can be solved and at the same time, those modules 400 and 450 can be manufactured at a much lower cost than required in conventional techniques.

In an example illustrated in FIG. 4, it is obvious to those of ordinary skill in the art that it is possible to properly adjust the shape of the second load electrode 471, the size of the convex surface 420 or to form an inclined surface at both sides of the convex surface 420 so that the second load electrode 471, when contacting the first-pole terminal 421 positioned in the convex surface 420, can easily slide towards the concave surface 410 from the convex surface 420. In addition, a plurality of first load electrodes 461 and second load electrodes 471 may be formed with proper intervals therebetween, so that electrical connection between those modules 400 and 450 can be easily maintained.

### Second Embodiment

The second embodiment of the present invention has an additional feature that the protruding portion 470 including the second load electrode 471 moves in a transverse direction and/or a longitudinal direction, in addition to features of the first embodiment of the present invention.

When the modules 400 and 450 disclosed in the first embodiment are manufactured to small sizes, the second load electrode 471, even if positioned on the convex surface 420, may not slide from the convex surface 420 to the concave surface 410. In other words, since gravity applied to the moving module 450 is not large due to light weight of the moving module 450, the second load electrode 471 may be held on the convex surface 420. Moreover, if tolerance is generated on the cradle surface 401, clearance may be generated on the load electrodes 461 and 471 and the concave-convex surface 430.

To improve the first embodiment, the second embodiment has added thereto a feature that the second load electrode 471 moves in a transverse direction and/or a longitudinal direction.

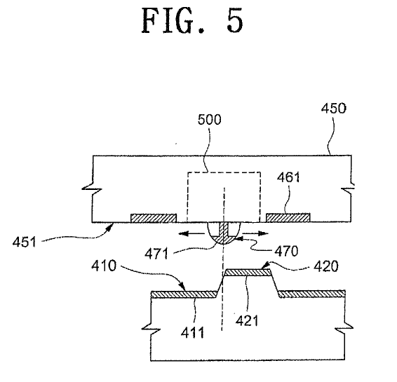

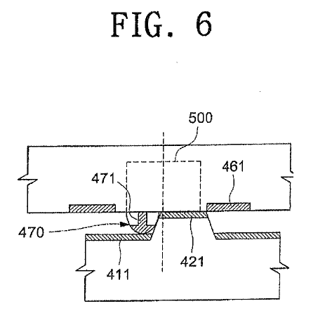

FIGS. 5 and 6 are cross-sectional views for explaining an operation where the second load electrode 471 moves in the transverse direction according to the second embodiment of the present invention.

As illustrated in FIG. 5, when the moving module 450 is cradled in the fixed module 400, the second load electrode 471 may come in contact with each other. In this case, the protruding portion 470 including the second load electrode 471 moves in the transverse direction such that it is settled in the first-pole terminal 411 positioned on the concave surface 410, as illustrated in FIG. 6. The transverse movement of the second load electrode 471 is preferably performed by a transverse movement unit 500 included in the moving module 450.

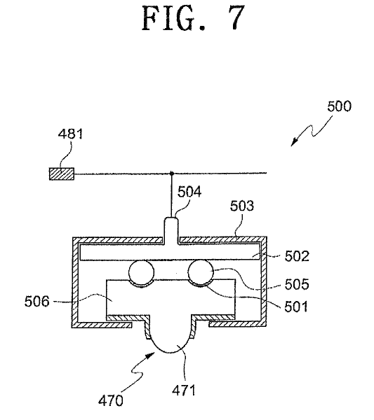

FIG. 7 illustrates an example of the transverse movement unit 500. As illustrated in FIG. 7, the transverse movement unit 500 includes a conductive movable member 506 connected to the second movable electrode 471, a plurality of grooves 501 formed in a back surface of the conductive movable member 506, a plurality of rotation members 505 inserted into the grooves 501, a conductive support 502 supporting the rotation members 505, and a housing receiving the aforementioned members 471, 502, 505 and 506. Since the rotation members 505 are manufactured as conductive members, electrical connection between the second load electrode 471 and the support 502 can be made through the rotation members 505. In this case, it is preferable that a lubricant be applied for smooth rotation of the rotation members 505, in particular, a conductive lubricant for establishing electrical connection.

A conductive lubricant is applied to the rotation members 505 to enable electrical connection between the second load electrode 471, and the rotation members 505 and the support 502. One end 504 of the support 502 is connected to the second pole 481 of the moving module load in order to deliver an electrical signal being input from the second load electrode 471 and to output an electrical signal being input from the second pole 481 of the moving module load through the second load electrode 471.

At least one transverse movement unit 500 is preferably in the moving module 450, and at least one second load electrode 471 is positioned in each transverse movement unit 500. That is, a plurality of second load electrodes 471 may be formed in the conductive movable member 506.

According to another aspect of the second embodiment, a longitudinal movement unit 510 for moving the second load electrode 471 in the longitudinal direction may be further included.

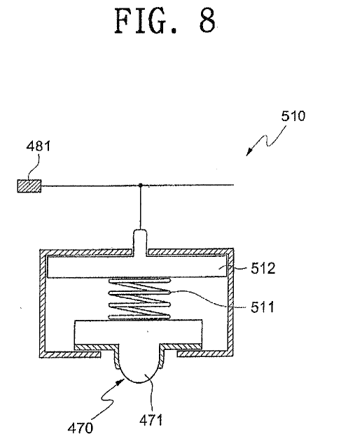

FIG. 8 illustrates an example of the longitudinal movement unit 510. As illustrated in FIG. 8, the longitudinal movement unit 510 includes an elastic member 511 connected to the protruding portion 470 having the second load electrode 471 and a support 512 for supporting the elastic member 511. Preferably, the elastic member 511 and the support 512 all are manufactured as conductors, thereby enabling electrical connection between the protruding portion 470 and the second pole 481 of the moving module load.

The longitudinal movement unit 510 illustrated in FIG. 8 is merely an example of a movement unit for moving the protruding portion 470 having the second load electrode 471 in the longitudinal direction, and the protruding portion 470 may be moved by using various other members.

When the second load electrode 471 is moved as illustrated in FIG. 8, generation of clearance between the second load electrode 471 and the concave surface 410 can be prevented in spite of tolerance in height across the concave surfaces 410.

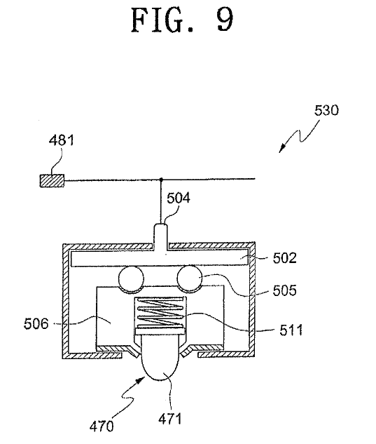

The longitudinal movement unit 510 and the transverse movement unit 500 may be manufactured as one unit. FIG. 9 illustrates a movement unit 530 for moving the protruding portion 470 in the transverse direction and the longitudinal direction.

When the protruding portion 470 is moved in various directions by using the illustrated electrical connection system, the second load electrode 471 included in the moving module 450 can easily slide along the concave-convex surface 430. Moreover, even if tolerance is generated in the cradle surface 401 of the load module, clearance between the moving module 450 and the load module can be prevented.

### Third Embodiment

The third embodiment is an improvement of the moving module 450. The third embodiment further includes a push type on-off switch for controlling an electrode pin 660 moving in a direction perpendicular to the contact surface 451. The push type on-off switch performs various operations according to various aspects of the present invention, in which the electrode pin 660 included in a push type on-off switch 600A suggested according to the third embodiment is withdrawn or protrudes in the direction perpendicular to the contact surface 451. In addition, the push type on-off switch 600A according to the third embodiment turns on or off electrical connection between the electrode pin 660 and the second load electrode 471 as the electrode pin 660 protrudes or is withdrawn.

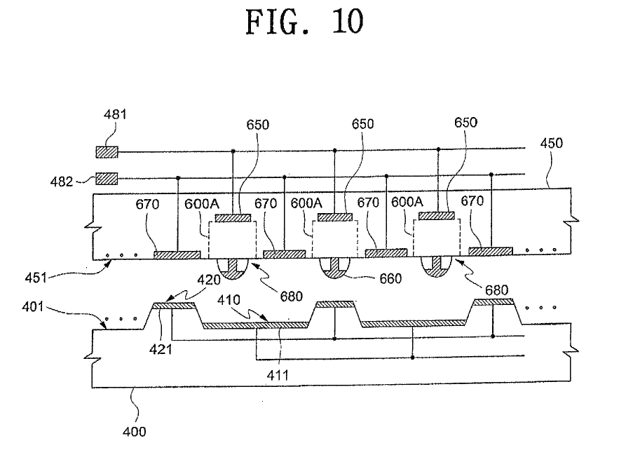

FIG. 10 is a cross-sectional view illustrating the third embodiment where the push type on-off switch 600A is added. As illustrated in FIG. 10, the fixed module 400 used in the third embodiment of the present invention is the same as used in the first and second embodiments.

The moving module 450 illustrated in FIG. 10 includes the contact surface 451 on which a first load electrode 670 corresponding to the first-pole terminal 421 is provided and in which a plurality of holes 680 are provided. Each of the plurality of holes 680 is provided with the push type on-off switch 600A.

The first load electrode 670 is connected to the first pole 482 of the moving module load and the electrode pine 660 is connected to the second pole 481 of the moving module load through the second load electrode 650. More specifically, the electrode pin 660, when protruding, is connected to the second load electrode 650, and is released from the second load electrode 650 when being withdrawn. It is preferable that the first load electrode 670 and the second load electrode 650 be insulated to prevent a problem such as a short circuit.

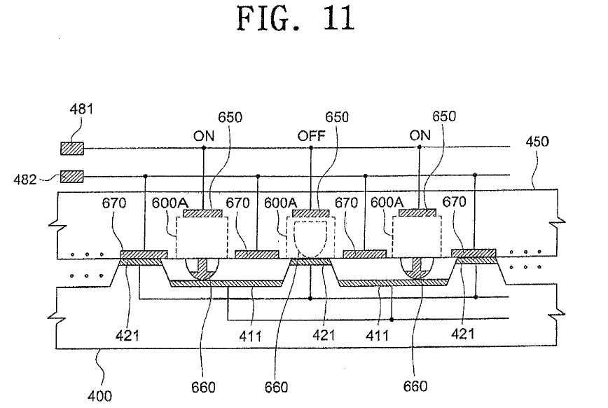

As illustrated in FIG. 11, as the electrode pin 660 is in contact with the convex surface 420 or the concave surface 410 at the fixed module 400, the push type on-off switch 600A causes the electrode pin 660 to be withdrawn or protrude in the longitudinal direction by using an elastic member.

As shown in FIG. 11, when the electrode pin 660 protrudes towards the cradle surface 401, it means that the electrode pin 660 is positioned on the concave surface 410, whereby the electrode pin 660 and the second load electrode 650 are short-circuited (i.e., in an ‘on’ state). On the other hand, when the electrode pin 660 is withdrawn towards the contact surface 451, it means that the electrode pin 660 is positioned on the convex surface 420, whereby the electrode pin 660 and the second load electrode 650 are electrically opened (i.e., in an ‘off’ state).

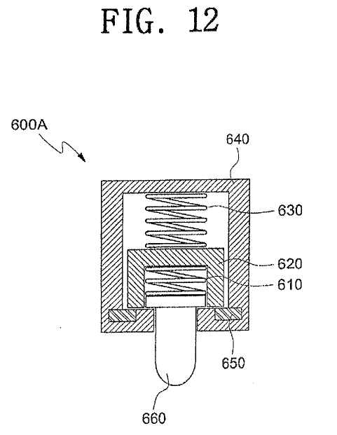

FIG. 12 is a cross-sectional view illustrating an example of the push type on-off switch 600A used in the third embodiment. As shown in FIG. 12, the push type on-off switch 600A includes a first elastic member 610 which is connected to one side of the electrode pin 660 and is elastically transformed in a direction perpendicular to the contact surface 451, a conductive member 620 which is connected to the first elastic member 610 to move in the direction perpendicular to the contact surface 451 and is electrically connected to the electrode pin 660, a second elastic member 630 which is connected to one side of the conductive member 620 and is elastically transformed in the direction perpendicular to the contact surface 451, and a support 640 which supports the second elastic member 630.

Since the conductive member 620 may be connected to the second load electrode 650 according to its position, it can deliver an electrical signal from the electrode pin 660 to the second load electrode 650 and an electrical signal from the second load electrode 650 to the electrode pin 660.

When a pressure of less than a first threshold is applied to the electrode pin 660 (i.e., the electrode pin 660 is positioned on the second-pole terminal 411), the conductive member 620 is in contact with the second load electrode 650, for which electrical connection between the electrode pin 660 and the second load electrode 650 is maintained. That is, the second-pole terminal 411 and the second load electrode 650 are electrically connected through the electrode pin 660.

However, when a pressure of greater than the first threshold is applied to the electrode pin 660 (i.e., the electrode pin 660 is positioned on the first-pole terminal 421), connection of the conductive member 620 to the second load electrode 650 is released, for which electrical connection between the electrode pin 660 and the second load electrode 650 is released. In other words, the second-pole terminal 411 and the second load electrode 650 are electrically opened.

When the third embodiment is applied to a charging system, it may function as will be described below. For example, it is assumed that the fixed module 400 is a charging device including a power supply source (not shown), the moving module 450 is a portable device including a battery (not shown), the second-pole terminal 411 and the second load electrode 650 are VCC terminals of a charging power and a battery having a predetermined potential (e.g., ‘5’ volt) and the first-pole terminal 421 and the first load electrode 670 are GND terminals of the charging power and the battery having a ground potential.

In this case, only when the electrode pin 660 protrudes, the second-pole terminal 411 and the second load electrode 650 are electrically connected, thus maintaining electrical connection between the VCC terminals. When the electrode pin 660 is withdrawn, the second-pole terminal 411 and the second load electrode 650 are electrically isolated from each other, thus releasing electrical connection between the VCC terminals.

By properly adjusting the number and arrangement of the electrode pin 660, one or more electrode pins 660 can be connected to the second-pole terminal 411 even when the moving module 450 is freely positioned. Therefore, it is desirable to properly adjust the number and arrangement of the electrode pin 660.

### Fourth Embodiment

The fourth embodiment is a further improvement of the moving module 450. The fourth embodiment has added thereto a push type selection switch 600B, in which the electrode pin 660 is moved in a direction perpendicular to the contact surface 451. In the fourth embodiment, the first load electrode 670 is not provided on the contact surface 451, and the electrode pin 660 is connected to the first load electrode 670 or the second load electrode 650 included in the moving module 450 as the electrode pin 660 is withdrawn or protrudes.

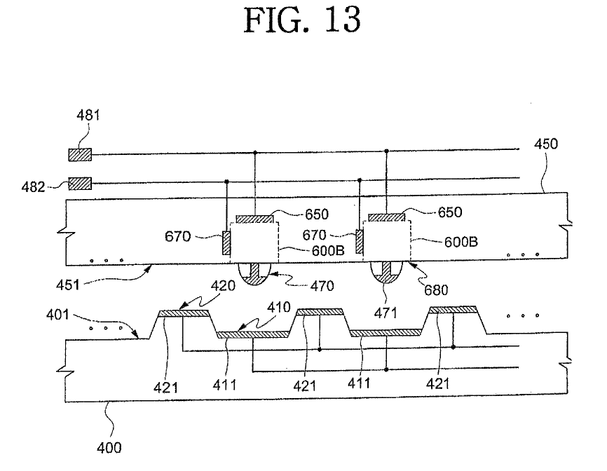

FIG. 13 is a cross-sectional view illustrating the fourth embodiment having added thereto the push type selection switch 600B. As illustrated in FIG. 13, the fixed module 400 is the same as used in the first through third embodiments.

The moving module 450 of FIG. 13 includes the contact surface 451 on which the plurality of holes 680 are provided. Each of the plurality of holes 680 is provided with the push type selection switch 600B which includes the electrode pin 660 contacting the first-pole terminal 421 and the second-pole terminal 411.

The electrode pin 660 according to the fourth embodiment corresponds to the second-pole terminal 411 when protruding and corresponds to the first-pole terminal 421 when being withdrawn.

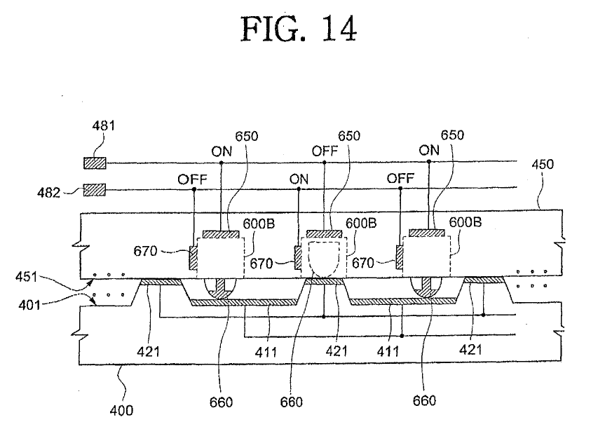

As illustrated in FIG. 14, as the electrode pin 660 is in contact with the convex surface 420 and the concave surface 410 at the fixed module 400, the push type selection switch 600B causes the electrode pin 660 to be withdrawn or protruding in the longitudinal direction.

As shown in FIG. 14, when the electrode pin 660 protrudes towards the cradle surface 401, it is connected to the second load electrode 650 provided in the moving module 450. When the electrode pin 660 is withdrawn towards the contact surface 451, it is connected to the first load electrode 670 provided in the moving module 450.

The second load electrode 650, connected to the second pole 481 of the moving module load, corresponds to the second-pole terminal 411. The first load electrode 670, connected to the first pole 482 of the moving module load, corresponds to the first-pole terminal 421.

As is shown, the second-pole terminal 411 is connected to the second pole 481 of the moving module load through the electrode pin 660 when the electrode pin 660 protrudes, whereas the first-pole terminal 421 is connected to the first pole 482 of the moving module load when the electrode pin 660 is withdrawn.

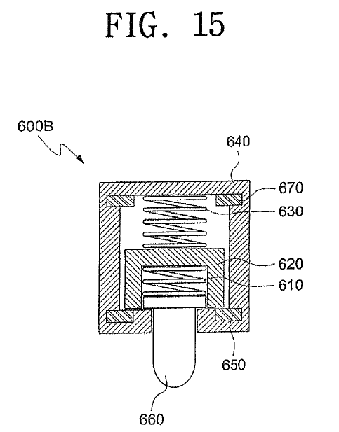

FIG. 15 is a cross-sectional view illustrating an example of the push type selection switch 600B used in the fourth embodiment. As shown in FIG. 15, the push type selection switch 600B includes the first elastic member 610 which is connected to one side of the electrode pin 660 and is elastically transformed in a direction perpendicular to the contact surface 451, the conductive member 620 which is connected to the first elastic member 610 to move in the direction perpendicular to the contact surface 451 and is electrically connected to the electrode pin 660, the second elastic member 630 which is connected to one side of the conductive member 620 and is elastically transformed in the direction perpendicular to the contact surface 451, and the support 640 which supports the second elastic member 630.

Since the conductive member 620 may be connected to the second load electrode 650 or the first load electrode 670 according to its position, the electrode pin 660 and the first and second load electrodes 650 and 670 may be selectively short-circuited with each other.

When a pressure of less than the first threshold is applied to the electrode pin 660 (i.e., the electrode pin 660 is positioned on the second-pole terminal 411), the conductive member 620 is in contact with the second load electrode 650, for which the electrode pin 660 and the second load electrode 650 are short-circuited.

When a pressure of greater than a second threshold is applied to the electrode pin 660 (i.e., the electrode pin 660 is positioned on the first-pole terminal 421), the conductive member 620 is in contact with the first load electrode 670 and the electrode pin 660 and the first load electrode 670 are short-circuited with each other.

A plurality of electrode pins 660 may be formed and an interval therebetween may be liberally determined.

### Fifth Embodiment

The fifth embodiment is a further improvement of the moving module 450 and the fixed module 400. In the fifth embodiment, unlike in the third and fourth embodiments, the electrode pin 660 is withdrawn towards the contact surface 451 in normal times. In the third and fourth embodiments described above, the electrode pin 660 protrudes out of the contact surface 451 in normal times, causing inconvenience to a user who uses the moving module 450 and a problem in terms of product design. Thus, in the fifth embodiment, a suggestion will be made in which the electrode pin 660 is withdrawn towards the contact surface 451 in normal times and protrudes when necessary.

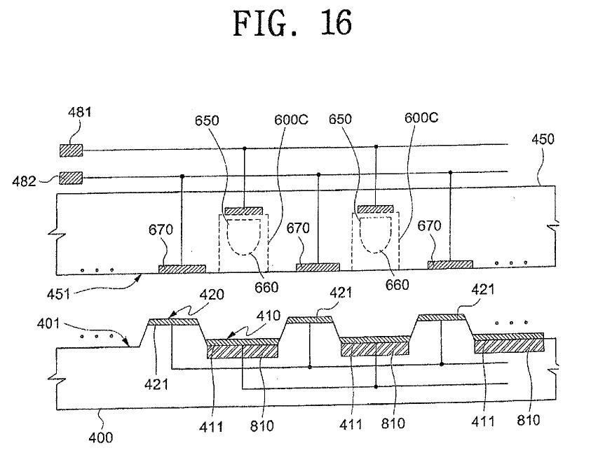

FIG. 16 is a cross-sectional view illustrating an example of an electrical connection system including a depressed electrode unit 600C according to the fifth embodiment. As illustrated in FIG. 16, the fixed module 400 includes the convex surface 420 and the concave surface 410 and includes the second-pole terminal 411 and the first-pole terminal 421, as previously mentioned.

The fixed module 400 preferably further includes a magnet 810 on a back surface of the concave surface 410. The magnet 810 is provided to cause the electrode pin 660 made of a ferromagnetic substance according to the fifth embodiment to protrude out of the contact surface 451.

The moving module 450 includes at least one electrode pin 660 made of a ferromagnetic substance. When a magnetic force of the magnet 810 reaches the electrode pin 660, the electrode pin 660 is turned to a protruding position outward from the contact surface 451. When the magnetic force of the magnet 810 does not reach the electrode pin 660, the electrode pin 660 is turned to a withdrawn position inward from the contact surface 451.

It is more preferable that the withdrawn position be positioned deeper than a planar portion of the contact surface 451 in order to prevent the electrode pin 660 from contacting the first-pole terminal 421.

The electrode pin 660 is connected to the second load electrode 650 corresponding to the second-pole terminal 411. Thus, when the electrode pin 660, protruding due to the magnet 810 disposed adjacent to the concave surface 410, is in contact with the second-pole terminal 411, electrical connection between the second-pole terminal 411 and the second load electrode 650 is maintained. In this case, the second load electrode 650 is connected to the second pole 481 of the moving module load, resulting in a short circuit between the second-pole terminal 411 and the second pole 481 of the moving module load.

Since the magnetic 810 is not provided around the convex surface 420, the electrode pin 660 made of a ferromagnetic substance does not protrude even when positioned on the first-pole terminal 421, thereby preventing contact between the electrode pin 660 and the first-pole terminal 421.

At least one first load electrode 670 corresponding to the first-pole terminal 421 is provided on the contact surface 451 of the moving module 450 of FIG. 16. The first load electrode 670 is connected to the first pole 482 of the moving module load. Thus, when the first-pole terminal 421 and the first load electrode 670 come into contact, the first-pole terminal 421 and the first pole 482 of the moving module load are short-circuited.

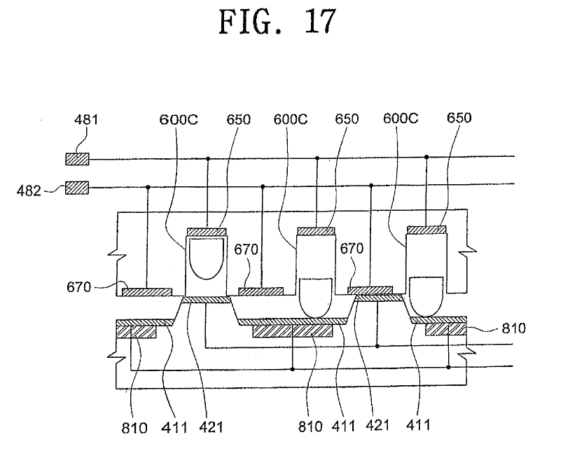

As illustrated in FIG. 17, when the electrode pin 660 is positioned on the magnet 810, i.e., on the second-pole terminal 411, it protrudes and thus is in contact with the second-pole terminal 411. When the electrode pin 660 is positioned on the first-pole terminal 421 it is in the withdrawn position and thus does not contact the first-pole terminal 411.

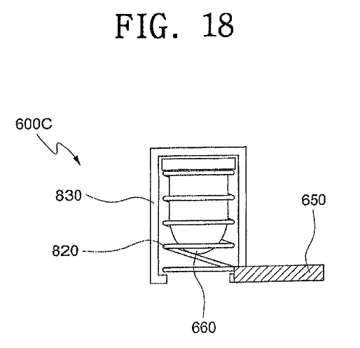

FIG. 18 is a cross-sectional view illustrating an example of the depressed electrode unit 600C used in the fifth embodiment. As shown in FIG. 18, the depressed electrode unit 600C includes a first elastic member 820 which is connected to one side of the electrode pin 660 and is elastically transformed in a direction perpendicular to the contact surface 451, a support 830 which supports the first elastic member 820, and the second load electrode 650 which is electrically connected to the electrode pin 660 through the first elastic member 820.

The first elastic member 820 causes the electrode pin 660 to be disposed in the withdrawn position inward from the contact surface 451 in normal times when a magnetic force does not reach the electrode pin 660.

The electrode pin 660 is electrically connected to the second load electrode 650, and it protrudes only when being adjacent to the second-pole terminal 411. Thus, the electrode pin 660 is connected only to the second-pole terminal 411 without being connected to the first-pole terminal 421.

The number of electrode pins 660 can be determined variously, and more electrode pins mean more advantages for electric connection.

### Sixth Embodiment

The sixth embodiment is a further improvement of the moving module 450 and the fixed module 400. The sixth embodiment has a feature that the electrode pin 660 is disposed in the withdrawn position in normal times and is disposed in the protruding position when a magnet is adjacent thereto like in the fifth embodiment. However, the fifth embodiment is associated with a structure where the electrode pin 660 and the second load electrode 650 are electrically connected at all times, whereas the sixth embodiment is associated with a structure where the electrode pin 660 and the second load electrode 650 are electrically on/off in some cases.

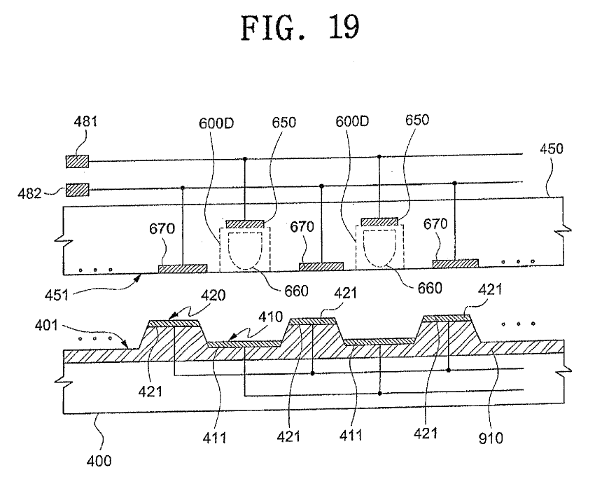

FIG. 19 is a cross-sectional view illustrating an example where a push type on-off switch 600D is included according to the sixth embodiment. As illustrated in FIG. 19, the fixed module 400 includes the convex surface 420 and the concave surface 410 like in the first through fifth embodiments, and includes the second-pole terminal 411 and the first-pole terminal 421. The fixed module 400 further includes a magnet 910 provided on back surfaces of the first-pole terminal 421 and the second-pole terminal 411. The magnet 910 is provided to cause the electrode pin 660 made of a ferromagnetic substance according to the sixth embodiment to protrude out of the contact surface 451.

The moving module 450 illustrated in FIG. 19 includes at least one electrode pin 660 made of a ferromagnetic substance. When a magnetic force of the magnet 910 reaches the electrode pin 660, the electrode pin 660 is turned to the protruding position outward from the contact surface 451. When the magnetic force of the magnet 910 does not reach the electrode pin 660, the electrode pin 660 is turned to the withdrawn position inward from the contact surface 451.

The moving module 450 includes the contact surface 451 on which the first load electrode 670 corresponding to the first-pole terminal 421 is provided and a plurality of openings, i.e., holes 680 are provided. Each of the plurality of holes 680 is provided with the push type on-off switch 600D which further includes the electrode pin 660 contacting the first-pole terminal 421 and the second-pole terminal 411.

The first load electrode 670 is connected to the first pole 482 of the moving module load, and the electrode pin 660 is connected to the second pole 481 of the moving module load through the second load electrode 650. More specifically, the electrode pin 660 is connected to the second load electrode 650 when protruding by the magnet 910, and is released from the second load electrode 650 when being withdrawn. It is preferable that the first load electrode 670 and the second load electrode 650 be insulated from each other to prevent a problem such as a short circuit.

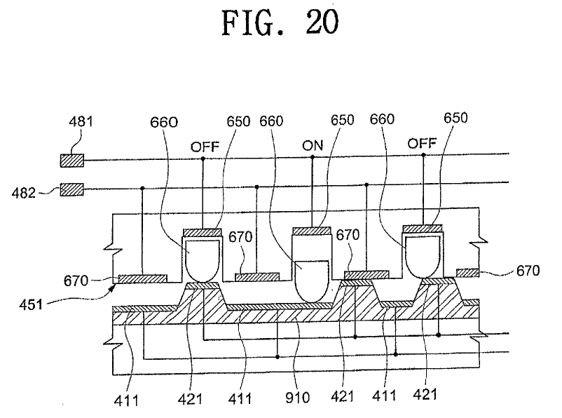

As illustrated in FIG. 20, the push type on-off switch 600D causes the electrode pin 660 to protrude in the longitudinal direction as the electrode pin 660 approaches the magnet 910, and returns the electrode pin 660 to the withdrawn position as the electrode pin 660 becomes distant from the magnet 910.

As shown in FIG. 20, when the electrode pin 660 protrudes towards the cradle surface 401, it means that the electrode pin 660 is positioned on the concave surface 410, whereby the electrode pin 660 and the second load electrode 650 are short-circuited (i.e., in an ‘on’ state). On the other hand, when the electrode pin 660 is withdrawn towards the contact surface 451, it means that the electrode pin 660 is positioned on the convex surface 420, whereby the electrode pin 660 and the second load electrode 650 are electrically opened (i.e., in an ‘off’ state).

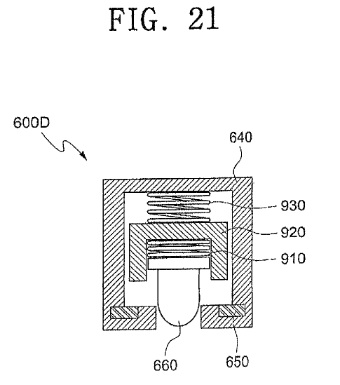

FIG. 21 is a cross-sectional view illustrating an example of the push type on-off switch 600D used in the sixth embodiment. As shown in FIG. 21, the push type on-off switch 600D includes a first elastic member 916 which is connected to one side of the electrode pin 660 and is elastically transformed in a direction perpendicular to the contact surface 451, a conductive member 920 which is connected to the first elastic member 916 to move in the direction perpendicular to the contact surface 451 and is electrically connected to the electrode pin 660, a second elastic member 930 which is connected to one side of the conductive member 920 and is elastically transformed in the direction perpendicular to the contact surface 451, and the support 640 which supports the second elastic member 930.

The first elastic member 916 and the second elastic member 930 are preferably compression springs which contracts in normal times to prevent the electrode pin 660 from being exposed to outside when the magnetic force does not reach the electrode pin 660.

Since the conductive member 920 is connected to the second load electrode 650 when the electrode pin 660 protrudes by the magnetic force, it can deliver an electrical signal from the electrode pin 660 to the second load electrode 650 and an electrical signal from the second load electrode 650 to the electrode pin 660.

When a pressure of less than the first threshold is applied to the electrode pin 660 (i.e., the electrode pin 660 is positioned on the second-pole terminal 411), the conductive member 920 is in contact with the second load electrode 650, for which the electrode pin 660 and the second load electrode 650 are short-circuited. That is, the second-pole terminal 411 and the second load electrode 650 are electrically connected through the electrode pin 660.

However, when a pressure of greater than the first threshold is applied to the electrode pin 660 (i.e., the electrode pin 660 is positioned on the first-pole terminal 421), the conductive member 920 is electrically separated from the second load electrode 650, for which the electrode pin 660 and the second load electrode 650 are electrically opened.

By properly adjusting the number and arrangement of the electrode pin 660, one or more electrode pins 660 can be connected to the second-pole terminal 411 even when the moving module 450 is freely positioned. Therefore, it is desirable to properly adjust the number and arrangement of the electrode pin 660.

### Seventh Embodiment

The seventh embodiment is a further improvement of the moving module 450. The seventh embodiment has added thereto a push type selection switch which causes the electrode pin 660 to be withdrawn in normal times. However, in the sixth embodiment, the first load electrode 670 is not provided on the contact surface 451, and the electrode pin 660 is connected to the first load electrode 670 or the second load electrode 650 included in the moving module 450 as the electrode pin 660 is withdrawn or protrudes.

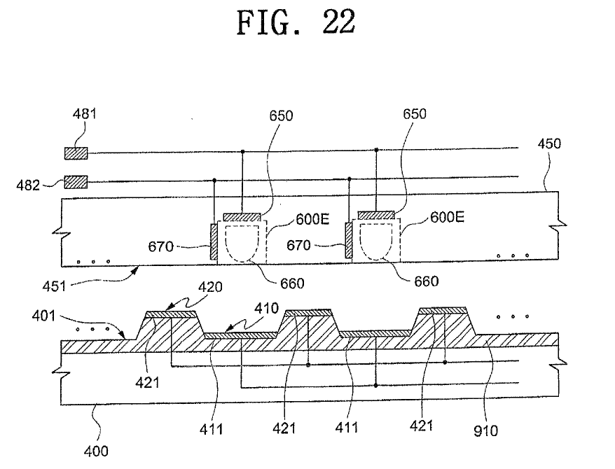

FIG. 22 is a cross-sectional view illustrating the seventh embodiment having added thereto a push type selection switch 600E. As illustrated in FIG. 22, the fixed module 400 of FIG. 22 is the same as that used in the sixth embodiment.

The moving module 450 of FIG. 22 includes the contact surface 451 on which a plurality of openings, i.e., holes 680 are provided. Each of the plurality of holes 680 is provided with the push type selection switch 600E which further includes the electrode pin 660 contacting the first-pole terminal 421 and the second-pole terminal 411.

The electrode pin 660 according to the seventh embodiment corresponds to the second-pole terminal 411 when protruding and corresponds to the first-pole terminal 421 when being withdrawn.

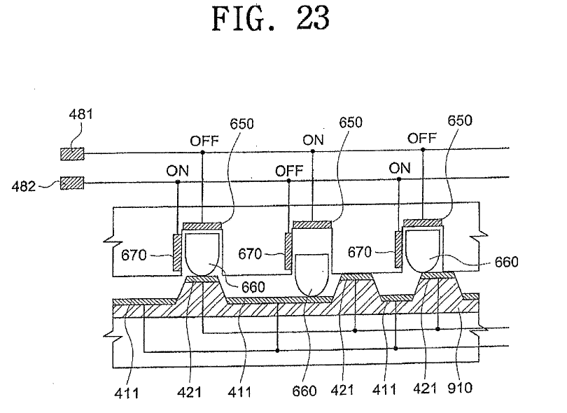

As illustrated in FIG. 23, as the electrode pin 660 comes in contact with the convex surface 420 and the concave surface 410 at the fixed module 400, the electrode pin 660 is withdrawn or protrudes in the longitudinal direction.

As shown in FIG. 23, when the electrode pin 660 protrudes towards the cradle surface 401, it is connected to the second load electrode 650 provided in the moving module 450. When the electrode pin 660 is withdrawn towards the contact surface 451, the electrode pin 660 is connected to the first load electrode 670 provided in the moving module 450.

The second load electrode 650, connected to the second pole 481 of the moving module load, corresponds to the second-pole terminal 411. The first load electrode 670, connected to the first pole 482 of the moving module load, corresponds to the first-pole terminal 421.

As shown in FIG. 23, when the electrode pin 660 protrudes, the second-pole terminal 411 and the second pole 481 of the moving module load are connected to each other through the electrode pin 660. When the electrode pin 660 is withdrawn, the first-pole terminal 421 and the first pole 482 of the moving module load are connected to each other through the electrode pin 660.

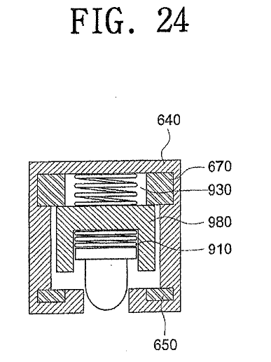

FIG. 24 is a cross-sectional view illustrating an example of the push type selection switch 600E used in the seventh embodiment. As illustrated in FIG. 24, the push type selection switch 600E includes the first elastic member 916 which is connected to one side of the electrode pin 660 and is elastically transformed in a direction perpendicular to the contact surface 451, a conductive member 980 which is connected to the first elastic member 916 to move in the direction perpendicular to the contact surface 451 and is electrically connected to the electrode pin 660, the second elastic member 930 which is connected to one side of the conductive member 980 and is elastically transformed in the direction perpendicular to the contact surface 451, and the support 640 which supports the second elastic member 930.

The first elastic member 916 and the second elastic member 930 are preferably compression springs which contracts in normal times to prevent the electrode pin 660 from being exposed to outside when the magnetic force does not reach the electrode pin 660. In addition, if the conductive member 980 is made of a ferromagnetic substance, the electrode pin 660 and the conductive member 980 move together when the magnetic force reaches the electrode pin 660. As a result, electrical connection between the conductive member 980 and the first load electrode 670 may be unintentionally opened. Therefore, it is preferable that the conductive member 980 be made of other substances than a ferromagnetic substance, i.e., a paramagnetic substance, a diamagnetic substance, a non-magnetic substance, and the like.

Since the conductive member 980 is connected to the second load electrode 650 or the first load electrode 670 according to its position, the electrode pin 660, and the first and second load electrodes 650 and 670 may be selectively short-circuited.

When a pressure of less than the first threshold is applied to the electrode pin 660 (i.e., the electrode pin 660 is positioned on the second-pole terminal 411), the conductive member 980 is in contact with the second load electrode 650, for which the electrode pin 660 and the second load electrode 650 are short-circuited.

However, when a pressure of greater than the second threshold is applied to the electrode pin 660 (i.e., the electrode pin 660 is positioned on the first-pole terminal 421), the conductive member 980 is in contact with the first load electrode 670, for which the electrode pin 660 and the first load electrode 670 are short-circuited.

A plurality of electrode pins 660 may be formed and an interval therebetween may be liberally determined.

When the first through seventh embodiments are used, electrical connection is possible irrespective of a position of each module. For example, when the present invention is used in a charging device for a portable apparatus, charging is possible regardless of the position of the portable apparatus, thereby providing convenient charging.

The preferred embodiments of the present invention described above have been disclosed for illustrative purposes, and those of ordinary skill in the art will appreciate that various modifications, changes, and additions can be made within the spirit and scope of the present invention, and such modifications, changes, and additions are within the scope of the appended claims.

### INDUSTRIAL APPLICABILITY

The present invention is applicable to various types of electronic modules, and thus it is reasonable to admit the industrial applicability of the present invention.

1. An electrical connection system between a fixed module and a moving module, characterized in that;
the fixed module comprises a cradle surface on which a concave-convex surface comprising a plurality of convex surfaces and a plurality of concave surfaces is repetitively arranged, in which a commonly connected first-pole terminal is formed on the plurality of convex surfaces and a commonly connected second-pole terminal is formed on the plurality of concave surfaces,
the moving module comprises a contact surface corresponding to the cradle surface of the fixed module, the contact surface comprising a planar portion and at least one protruding portion protruding from the planar portion,
a first load electrode, which is a conductive member connected to a first pole of a moving module load included in the moving module, is formed on at least a part of a surface of the planar portion, and a second load electrode, which is a conductive member connected to a second pole of the moving module load, is formed in an end portion of the protruding portion, the first load electrode and the second load electrode being insulated from each other,
the end portion of the protruding portion is received in any one of the plurality of concave surfaces of the fixed module such that the second load electrode is connected to the second-pole terminal of the fixed module, and
the first load electrode is connected to the first-pole terminal of the fixed module.

2. The electrical connection system of claim 1, further comprising a transverse movement unit for moving the protruding portion in a direction parallel to the contact surface.

3. The electrical connection system of claim 2, wherein the transverse movement unit comprises:
a conductive movable member connected to the protruding unit;
a rotation member inserted into a plurality of grooves formed on a surface of the conductive movable member to move the conductive movable member; and
a conductive support supporting the rotation member,
wherein the conductive support is connected to the second pole of the moving module load.

4. The electrical connection system of claim 1, further comprising a longitudinal movement unit for moving the protruding portion in a direction perpendicular to the contact surface.
